(19) United States
(12) Patent Application Publication
(10) Pub. No.: US 2007/0270148 A1
(43) Pub. Date: Nov. 22, 2007

(54) CANDIDATE SERVING CELL-DETERMINING METHOD OF A MOBILE SUBSCRIBER

(75) Inventors: Chun-Feng Yeh, Tainan City (TW); Chun-Chieh Yang, Taipei (TW)

Correspondence Address: LADAS & PARRY, 26 WEST 61ST STREET, NEW YORK, NY, 10023, US

(73) Assignee: BENQ CORPORATION

(21) Appl. No.: 11/748,787

(22) Filed: May 15, 2007

(30) Foreign Application Priority Data
May 19, 2006 (TW) 95117802

(51) Int. Cl. H04Q 7/20

(52) U.S. Cl. 455/436

(57) ABSTRACT

A candidate serving cell-determining method of a mobile subscriber in cell reselection tasks is disclosed. The mobile subscriber communicates with a mobile network by a serving cell, in which the mobile network comprises a plurality of neighbor cells including the serving cell. The candidate serving cell-determining method comprising the steps of: detecting the signal strengths of neighbor cells; choosing top N cells in signal strength as candidate serving cells; detecting afresh the signal strengths of the neighbor cells, and adding a predetermined weighting strength to each signal strength of the candidate serving cell so as to form the in-list signal strength of the respective candidate serving cell; and choosing top N cells from the neighbor cells by comparing the in-list signal strengths of the candidate serving cells with the real signal strengths of the rest neighbor cells.

### FIELD OF THE INVENTION

The invention relates to a cell reselection method of a mobile subscriber, and more particularly to a method that can determine a candidate cell of the mobile subscriber.

### BACKGROUND OF THE INVENTION

Thanks to recent development in the personal communication network, convenience of the personal communication system has made the interpersonal communication more easily and simply, and also leads to the increasing population of the mobile subscribers (MS). The consumer (the mobile subscriber) can contact another mobile subscriber without limitation in time and place if and only if they both are in the reachable region of communication signals.

In the art, a wireless communication system comprises a plurality of base stations, and a single base station can further include a plurality of cells to provide communication service. In a global view, the plural cells in the same wireless communication system can be framed into a honeycomb arrangement to cover the whole reachable region. Such a wireless communication system is also called a cellular wireless communication system. For simplifying the description, please refer to FIG. 1, which shows schematically a typical wireless communication system.

As shown, a mobile subscriber (also called a mobile station or MS) 16, a first cell 12, and a second cell 14 of the wireless communication system 1 are included. The first cell 12 has a first cell region 121 and the second cell 14 has a second cell region 141 in order to offer communication service. The mobile subscriber 16 located in an overlapped area of the first cell region 121 and the second cell region 141 can transmit/receive signals to/from a wireless communication system 1 through the adjacent cell 12 or 14.

When the mobile subscriber 16 is turned on, the mobile subscriber 16 can start a process of cell selection. In the process, the mobile subscriber 16 firstly receives parameters of the first and the second cells 12, 14 transmitted through their own broadcast control channels (BCCH) and introduces two criteria (a path loss criterion to determine a C1 parameter and a cell reselection criterion to determine a C2 parameter) to judge the signal strength of the corresponding cell. Based on the preferable signal strength, a serving cell from the first cell 12 and the second cell 14 for the mobile subscriber 16 can be determined. As soon as the serving cell is determined, the mobile subscriber 16 can camp on the serving call to start the following communication works. Generally speaking, the preferable serving cell is the one that has a positive value in the C1 parameter and a highest value in the C2 parameter.

In accordance with the ETSI 05.08 (European Telecommunications Standards Institute) in link control, the mobile subscriber, already camping at a specific cell, can keep cell reselection tasks every few seconds. The mobile subscriber detects every BCCH signal strength of all the neighboring cells in the PLMN (Public Land Mobile Network) so as to stick to a preferable cell that provides a better communication quality.

During the process of the cell reselection, the mobile subscriber detects the BCCH signal strength upon all the neighbor cells in the BCCH allocation list (BA list) continuously, and the mobile subscriber seeks out top six signal-strong neighbor cells (non-serving carriers) to be the six candidate serving cells. The mobile subscriber updates the C2 parameters of the current serving cell and the candidate serving cells at the same time so as to find the most suitable cell to be the serving cell.

The mobile subscriber has to read the BCCH information from the candidate serving cells so as to calculate the cell reselection C2 parameter of the candidate serving cells. However, before reading the BCCH information, the mobile subscriber shall synchronize the FB (frequency correction burst) and the SB (synchronic-sation burst) to adjust possible error in time and frequency in order to read the BCCH information correctly. The mobile subscriber also reads the BSIC (base station identity code) to get the identity code of the serving cell.

The process of the cell reselection is carried on continuously. That is, the mobile subscriber keeps updating the candidacy of neighbor cells. Once the mobile subscriber advances a cell to be listed in the candidate list, the mobile subscriber will read the BCCH information of the new candidate serving cell in 30 seconds.

In order to meet ETSI 05.08, following situations may happen to the mobile subscriber. After finishing every detecting measurement of the neighbor cells, the mobile subscriber will report the measure result to the communication protocol stack. The average signal strength of the neighbor cells in the BA list are afresh calculated according to the measure result, the communication protocol stack, and an average value of the antecedent accumulative total signal strength. Then, the top six neighbor cells in signal strength, other than the current serving cell, can be determined to be the new candidate serving cells.

When the difference between the average signal strengths of the sixth and seventh neighbor cells is extremely small, it is quite possible that the sixth candidacy may flip frequently around these two cells. This will cause the mobile subscriber frequently to read the BCCH information of the new candidate cell. As a subsequence, the process in reading the FB and the SB so as to adjust the error in time and frequency for correctly reading the BCCH information, which will take about 30 seconds, would repeat frequently.

When the average signal strengths of a plurality of neighbor cells are close in a pretty small margin, it is also possible that any of them may be treated as the candidate serving cell from time to time. Once the candidacy in the serving cell is changed frequently, the mobile subscriber will waste power on non-stop reading the information of the FB and the SB of these neighbor cells.

Please refer to FIG. 2, which shows a flow chart for the cell reselection process of the mobile subscriber. As described above, the mobile subscriber executes the process of the cell reselection every few seconds so as to always have the top six strong-signal neighbor cells at the candidate list of the serving cell 18. As shown in S21, the top six average signal strengths received by the mobile subscriber arranged in an order of intensity are NC1 to NC6. The 7th average signal strength of the neighbor cell NC7 (having a rxlev 35) is close to the 6th average signal strength of the neighbor cell NC6 (having a rxlev 36).

After a short span, the mobile subscriber updates the signal measurement of all neighbor cells. As shown in S22, the signal strength of the cell NC6 (having the rxlev 34) is now lower than that of the cell NC7 (having the same rxlev 35), and so the cell NC7 becomes a new candidate cell at present. Therefore, the mobile subscriber reads the BCCH information of the cell NC7. However, in S23, after the mobile subscriber refreshes the signal measurement of all neighbor cells, the cell NC6 re-grasps the sixth candidacy over the cell NC7, and thus the mobile subscriber has to read the BCCH information of the cell NC6 again according to the communication standard.

During the cell reselection process as shown in FIG. 2, though the candidate serving cells are the same at the beginning and the final, yet, in the step S22, the mobile subscriber is forced to read the BCCH information of the cell NC7 including the FB and the SB due to a slight change in signal strength of the cell NC6. Apparently, it is doubtful if the frequent replacement of the candidacy in the lower rank (say the sixth, and even the fifth one) is worthy, for these low ranked cells are way behind to become the serving cell immediately.

Unfortunately, the aforesaid problem of wasting power in flipping the low-ranked candidate serving cells can not be solved by utilizing the conventional method of the cell reselection. So a method for determining the candidate serving cells is presented in this present invention to avoid unnecessary information reading in the cell reselection process.

### SUMMARY OF THE INVENTION

The object of the present invention is to provide a method for determining the candidate serving cells to prevent the mobile subscriber from changing the candidate serving cells while in meeting a temporary signal change during the cell reselection.

The candidate cell-determining method of the present invention is applied to a cell reselection process of a mobile subscriber. The mobile subscriber communicates with a mobile network by a serving cell, and the mobile network comprises the serving cell and a plurality of its neighbor cells. The candidate serving cell-determining method comprises following steps: detecting signal strength of the plural neighbor cells; choosing top N cells that have stronger signal strength among the plural neighbor cells; registering these N neighbor cells in a candidate serving cell list; adding a predetermined weighting strength (a hysteresis) to each of the N neighbor cells for representing the in-list signal strengths of the N neighbor cells.

### BRIEF DESCRIPTION OF THE DRAWINGS

The features, objects, and advantages of the present invention will become more apparent from the following detailed description of the preferred embodiment of this invention, with reference to the accompanying drawings, in which:

FIG. 1 illustrates a wireless communication system in prior art;

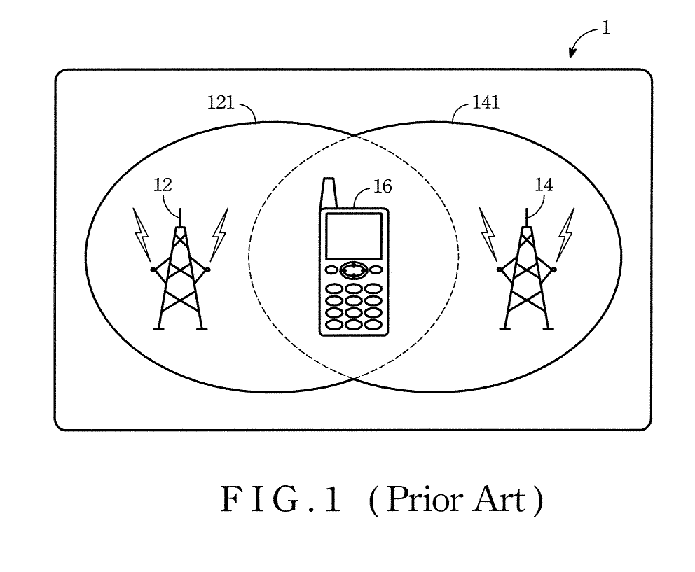

FIG. 2 is a flow chart of a cell reselection process of the mobile subscriber in prior art;

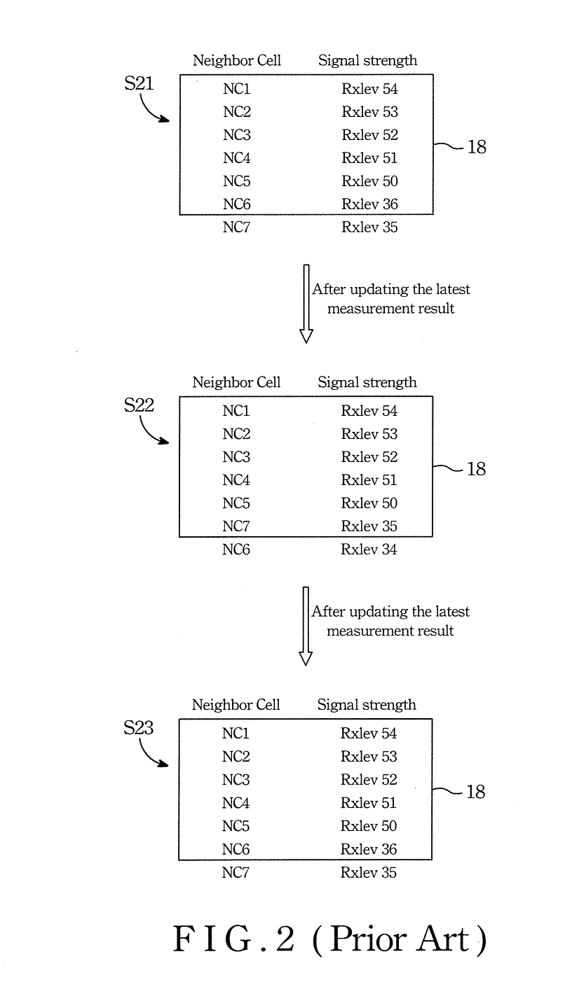

FIG. 3 illustrates schematically a preferred cell reselection process of the mobile subscriber in accordance with the present invention; and

FIG. 4 is a flow chart of the cell reselection process of FIG. 3.

### DETAILED DESCRIPTIONS OF THE PREFERRED EMBODIMENT

For solving the aforesaid problem of the cell reselection, a candidate serving cell-determining method of a mobile subscriber is provided to reduce the power consumption of the mobile subscriber. In the cell reselection process of the mobile subscriber, each of the neighbor cells listed as the candidate serving cells is added by a weighting strength to represent the in-list signal strengths of the candidate serving cells, such that the aforesaid flipping situation in the low-ranked candidate serving cells can be avoided for the signal strength of the candidate serving cell has been elevated to a higher level away from that of those not in the candidate list. Upon such an arrangement, the lowest-ranked cell in the list can be away from the challenge (in signal strength) of the top cell out of the list due to slight strength fluctuation.

After measuring all the neighbor cells every time, the mobile subscriber calculates each average signal strength (also called rxlev) of the neighbor cell in the BCCH allocation list and defines top six cells that have stronger signal strengths to be the candidate serving cells (excluding the current serving cell). In the present invention, each signal strength of the candidate serving cell is added by the weighting strength. Adding the weighting strength is only for a comparison purpose in determining a possible reselection and is not to alter the real signal strengths of both the candidate serving cells and the rest of the neighbor cells.

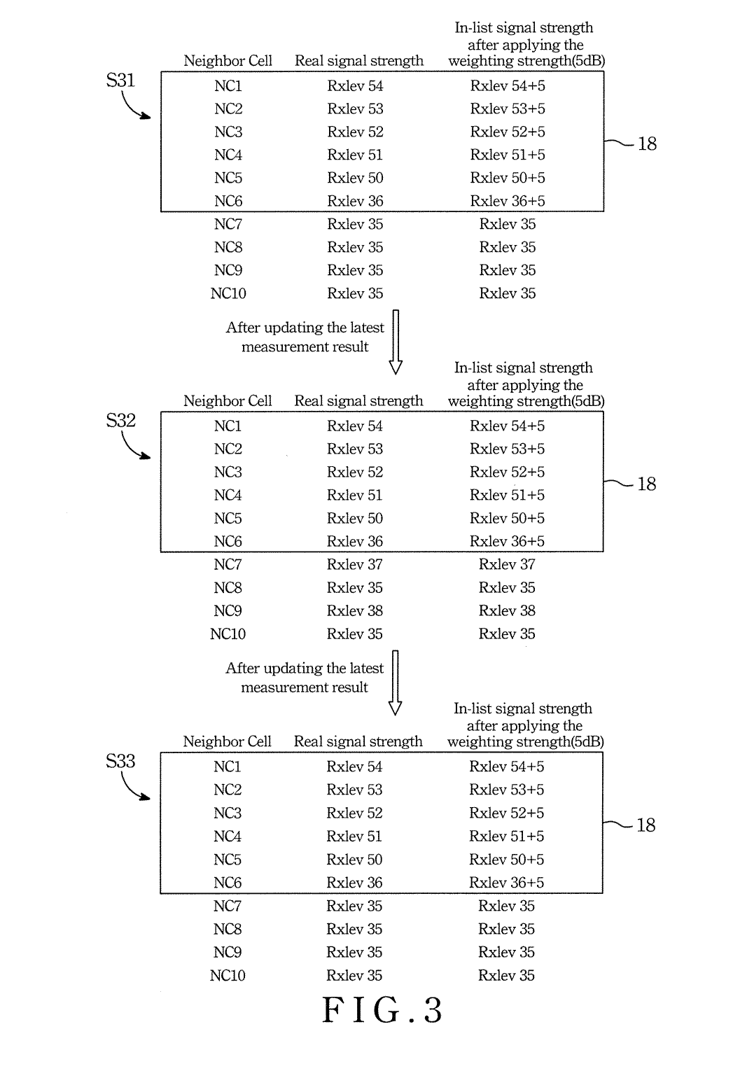

Please refer to FIG. 3 that illustrates schematically a preferred cell reselection process for the candidate serving cell-determining method in accordance with the present invention. In the first step S31, the mobile subscriber finishes the detection of a plurality of neighbor cells and determines top six neighbor cells NC1 to NC6 having stronger signal strengths than others to be the candidate serving cells 18. All neighbor cells are arranged in the listing, according to the ranking in the signal strength, and named from NC1 to NC10 as shown, in which the six candidate serving cells are labeled as NC1 to NC6. It is noted that the signal strengths of the cells NC6 to NC10 are closed to each other, with Rxlev 36 to NC6 and Rxlev 35 to any of NC7 to NC10. In the present invention, every candidate serving cell 18, from NC1 to NC6, is added by a predetermined weighting strength, 5 dB in this embodiment, to present the in-list signal strength of the candidate serving cell 18. It is noted that the in-list signal strength exists only for the comparison purpose in the cell reselection process of the mobile subscriber, and is not anyhow the real signal strength.

After a predetermined time, in the step S32, the mobile subscriber updates the measurement results. The comparison in the signal strengths of all the neighbor cells NC1-NC10 is performed upon the in-list signal strengths. That is, for example, the comparison between NC6 and NC7 is to compare Rxlev 36+5 of NC6 with Rxlev 37 of NC7. Upon such a comparison basis, the mobile subscriber determines and updates the top six candidate serving cells. After a further predetermined time, the mobile subscriber updates the measurement results again as shown in the step 33.

In the above-mentioned embodiment, any of the NC7-NC10 neighbor cells may be advanced to the candidate serving cell if and only if its real signal strength is ranked in the top six strengths among the in-list signal strengths of NC1-NC6 and the real signal strengths of NC7-NC10. In the case that a renewal in the candidate serving cells is necessary, the mobile subscriber is set to read the BCCH information of the new candidate serving cell. By providing the foregoing comparison method, slight perturbations in the low-ranked neighbor cells (say NC6 to NC10) won't initiate a computation on the FB and SB.

In the present invention, the real signal strength of each current candidate serving cell 18 is always added by the weighting strength 5 dB to obtain the in-list signal strength of the respective candidate serving cell 18 before the mobile subscriber begins every time to re-determine the top six candidate serving cells 18.

It is particular to note that, in the step 32, even the real signal strengths of the NC7 and NC9 are higher than that of the NC6, a renewal in the candidate serving cells won't be initiated for the in-list signal strength of the NC6 is still higher that any real signal strength of the NC7 or NC9.

In step 33, as shown by the new measurement results of all neighbor cells NC1-NC10, the small perturbation in signal strength exists of step S32 is no longer there, and thus the candidate neighbor cells are kept to the same NC1 to NC6 all the way from step S31 through step S33. Therefore, the mobile subscriber will not consume much power to read and process the BCCH information of the possible-change neighbor cells caused by the perturbation in step 32.

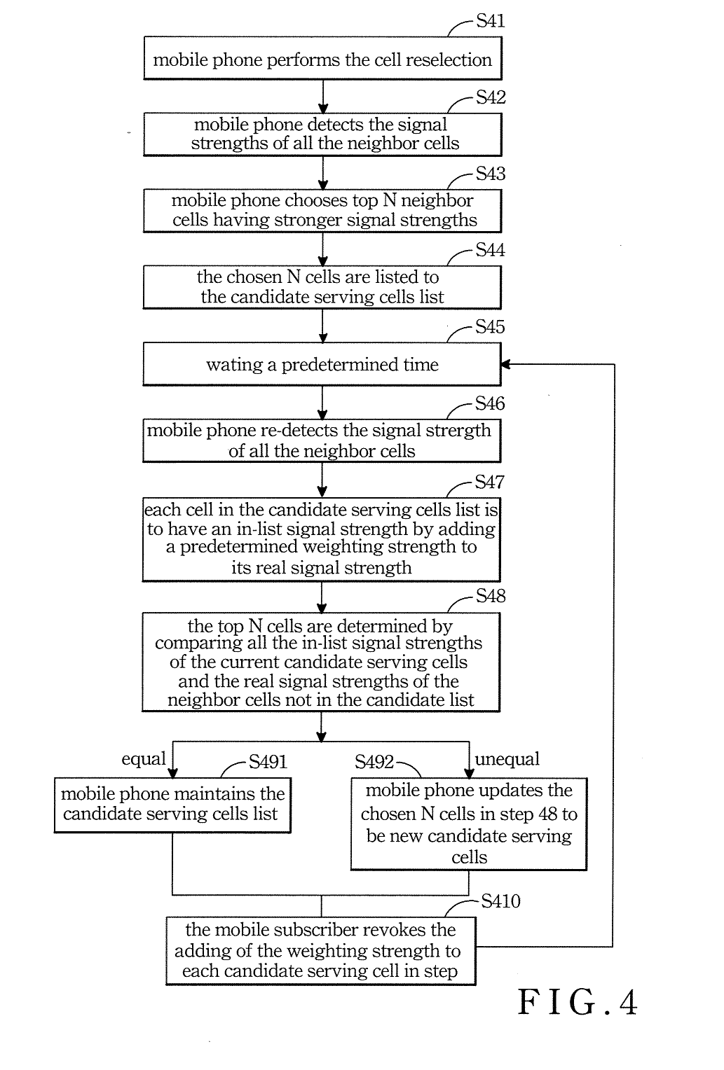

Please refer to FIG. 4, which shows a flow chart for the candidate serving cell-determining method of the mobile subscriber of FIG. 3. In step 41, the mobile subscriber performs the process of the cell reselection. Next in step 42, the mobile subscriber detects the signal strengths of all the neighbor cells and updates the measurement result of all the neighbor cells. In step 43, the mobile subscriber determines top N neighbor cells having stronger signal strengths. In step 44, the chosen N cells are listed to the candidate serving cells list.

In step 45, after waiting for a predetermined time, the mobile subscriber detects and updates the measurement results of all the neighbor cells again (step 46). In step 47, each cell in the candidate serving cells list is to have an in-list signal strength by adding a predetermined weighting strength to its real signal strength. In step 48, the top N cells are determined by comparing all the in-list signal strengths of the current candidate serving cells and the real signal strengths of the neighbor cells not in the candidate list. If no change is necessary in the candidacy of the neighbor cells, the mobile subscriber maintains the candidate serving cells list at step 491. Otherwise, in step 492, i.e. if there is any change in the top six cells having stronger signal strength, the mobile subscriber updates the chosen N cells (in step 48) to be the new candidate serving cells. In step 410, the mobile subscriber revokes the adding of the weighting strength to each candidate serving cell in step 47 and then repeats step 45 to step 48.

The weighting strength can be set in a preferable range for 3 dB to 5 dB, for example 5 dB in the above mentioned embodiments. In FIG. 4, the number N can be changed to meet the real situation, for example N to be six in the foregoing embodiments. In the above mentioned embodiments, the mobile subscriber detects the signal strengths of all neighbor cells every time and also updates the signal strengths of the serving cells at the same time. If the signal strength of one of the neighbor cells is higher than any in-list one of the candidate serving cells, the mobile subscriber may update the cell to be the new serving cell immediately.

In the conventional process of the cell reselection, when the signal strengths of the lower-ranked candidate serving cells and the following neighbor cells candidate serving cells are close, the mobile subscriber has no choice but to perform the updating of the candidate serving cells. Thus, such an unnecessary change to meet the temporary (possible) slight perturbation may consume substantially power of the mobile subscriber. On the other hand, the updating method of the candidate serving cells in accordance with the present invention provides the chance of advancing to the serving cell only to those neighbor cells that have obvious advantages in their signal strengths, and thus the group of the candidate serving cells won't be changed frequently while in meeting temporary fluctuation in signal strength. Thereby, the mobile subscriber can still provide good quality of communication, and the power consumption to unnecessary updating of the candidate serving cells can be avoided.

As compared with the conventional process of the cell reselection, the mobile subscriber reduces unnecessary changes of the candidate serving cells. By adding the weighting strength to each candidate serving cells, the mobile subscriber can have more rigid limitations to avoid the aforesaid problem of the unnecessary changes of the candidate serving cells and present its superiority in power saving.

Although the present invention and its advantages have been described in detail, as well as some variations over the disclosed embodiments, it should be understood that various other switches, substitutions and alterations can be made herein without departing from the spirit and scope of the invention as defined by the appended claims.

What is claimed is:

1. A method for a mobile subscriber to determine candidate serving cells, said mobile subscriber communicating with a mobile network by a serving cell, the mobile network comprising said serving cell and a plurality of neighbor cells, the method comprising:
(a) detecting signal strengths of said neighbor cells;
(b) choosing N neighbor cells with stronger signal strengths than other neighbor cells to be candidate serving cells;
(c) detecting the signal strengths of the neighbor cells, adding a predetermined weight strength to all the signal strengths of said candidate serving cells to form new signal strengths of said candidate serving cells; and
(d) choosing N neighbor cells with stronger signal strengths than other neighbor cells in step (c).

2. The method according to claim 1, said mobile subscriber having a candidate serving cell list, the method further comprising:
in step (b), registering said N cells into the candidate serving cell list; and
in said step (d), updating said candidate serving cell list when said N cells in the step (b) being different to said N cells in the step (d).

3. The method according to claim 1, further comprising:
(g) detecting a signal strength of said serving cell; and
(h) choosing a strongest signal strength of said candidate serving cell if strongest signal strength of said candidate serving cell larger than the signal strength of said serving cell.

4. The method according to claim 1, further comprising:
waiting a predetermined time before step (c).

5. The method according to claim 1, wherein said predetermined weighting strength ranges between 3 dB and 5 dB.

6. The method according to claim 1, wherein said N is equal to 6.

7. The method according to claim 1, further comprising:
(i) revoking said number N of said plurality of neighbor cells adding said weighting strength respectively;
(j) detecting afresh the signal strength of said plurality of neighbor cells, and said chosen number N of said plurality of neighbor cells at the step (d) adding said weighting strength respectively to represent the signal strength of said number N neighbor cells; and
(k) choosing number N of said plurality of neighbor cells having strongest signal strength after step (j).
